(19) United States
(12) Patent Application Publication
(10) Pub. No.: US 2018/0137288 A1
(43) Pub. Date: May 17, 2018

(54) SYSTEM AND METHOD FOR MODELING SECURITY THREATS TO PRIORITIZE THREAT REMEDIATION SCHEDULING

(71) Applicant: ERPScan B.V., Amsterdam (NL)

(72) Inventor: Alexander Polyakov, Moscow (RU)

(21) Appl. No.: 15/813,368

(22) Filed: Nov. 15, 2017

Related U.S. Application Data
(60) Provisional application No. 62/422,143, filed on Nov. 15, 2016.

(51) Int. Cl. G06F 21/57; G06Q 30/00

(52) U.S. Cl. CPC G06F 21/577; G06F 21/55; G06Q 30/016

(57) ABSTRACT

A system and method is disclosed for modeling electronic security threats of an enterprise architecture to determine optimal remediation actions to maximize security computing resources. An exemplary method provides a threat modeling tree that identifies electronic security threats and associated threat value identifiers linked to a data type that is threatened by the electronic security threats. Moreover, data analyzers scan assets in the enterprise architecture to determine whether the assets contain the identified critical data threatened by the electronic security threats. The method further includes identifying security vulnerabilities of the enterprise architecture that each threaten the identified critical data; determining risk values for each of the threat value identifiers based on a number and type of security vulnerabilities; and prioritizing the security vulnerabilities based on the determined risk value. Based on this priority, remediation actions can be selected to fix the security vulnerabilities to maximize use of security resources.

### CROSS-REFERENCE TO RELATED APPLICATIONS

The current application claims priority to U.S. Provisional Patent Application No. 62/422,143, entitled “Systems and Method of Threat Modeling to Determine Risks for Enterprise Applications”, filed Nov. 15, 2016, the entire contents of which are hereby incorporated by reference.

### TECHNICAL FIELD

The present disclosure generally relates to computing security, and, more particularly, to a system and method for modeling security threats to prioritize threat remediation scheduling.

### BACKGROUND

Currently, there are numerous solutions provided to identify vulnerabilities in different computing systems and application. Moreover, there are numerous “GRC” (governance, risk management, and compliance) systems where companies manage their high-level business risks where they can calculate the impact. However, existing GRC systems have no way to forecast the probability of those risks.

Furthermore, there are dozens of software solutions and applications, such as vulnerability scanners, static or dynamic code analysis tools and the like, that can identify misconfigurations and vulnerabilities of particular business asset, but information about a particular business risk related to that asset is outside the scope of such existing tools. In other words, these existing software solutions and applications have no ability to identify possible resulting risks if somebody exploits an identified vulnerability. As a result, mapping security vulnerabilities to threats and high-level risks affecting enterprises is still a question that needs to be resolved.

In view of these limitations on existing security systems, chief information security officers (“CISOs”) and other such security managers need a solution that provides them with the information on business risks (e.g., a vulnerability gives attackers access to personal records, or how such attackers will be able to commit sabotage or fraud) to their organization caused by hundreds of vulnerabilities across multiple assets identified by a particular scanner. More importantly, top managers need to understand a direct financial impact of such risks. For example, how much it will cost to the company if its human resources (“HR”) system that stores information about 5000 employees is compromised.

Moreover, given the number of security threats an business or enterprise can face on a daily basis, it is impossible to allocate the required computing resources to address every security threat the moment it is detected. Doing so might result in the committing of such resources to a relatively minor threat at first, which might often lead to a delay in these resources being available to address a major security threat that occurs and/or is detected after the minor threat. Therefore, as a starting point, such computer security systems need to be able to understand what kind of data is stored in every system (under its protection) and which processes this system is responsible for. However, this is just the tip of the iceberg for protecting such systems while trying to maximize computing resources for addressing such security threats.

### SUMMARY

Accordingly, a system and method is disclosed for modeling security threats to prioritize threat remediation scheduling and optimize use of computing resources to prioritize remediation of those security threats that are most critical to the security of electronic data stored and managed by an enterprise architecture.

Thus, in one exemplary aspect, a method is provided for modeling electronic security threats to assets of an enterprise architecture to determine an optimal remediation action to maximize use of security resources. In this aspect, the method includes providing a threat modeling tree that identifies at least one electronic security threat and a plurality of associated threat value identifiers that are each linked to a type of critical data that is threatened by the identified at least one electronic security threat; scanning at least one asset in the enterprise architecture to determine that the at least one asset contains the identified critical data threatened by the identified at least one electronic security threat; identifying, by at least one processor, a plurality of security vulnerabilities of the enterprise architecture that each threaten the identified critical data of the scanned at least one asset; determining, by the at least one processor, a risk value for each of the threat value identifiers based on a number and type of security vulnerabilities that threaten the identified critical data that is linked to the respective threat value identifier; prioritizing, by the at least one processor, the plurality of security vulnerabilities based on the determined risk value for each of the threat value identifiers; and determining, by the at least one processor, an electronic security remediation action to fix the security vulnerability of the plurality security vulnerabilities having a highest priority, such that the enterprise architecture maximize use of security resources.

In another exemplary aspect of the method, the determining of the risk value for each of the threat value identifiers comprises assigning one of a plurality of tiers of risk values based on the number of security vulnerabilities and whether each security vulnerability is remotely exploitable.

In another exemplary aspect of the method, each of the threat value identifiers is assigned a risk value tier of low, medium or high.

In another exemplary aspect, the method includes applying a different weighting factor to each of the plurality of tiers of risk values in order to prioritize the plurality of security vulnerabilities based on a sum of the weighted risk values for each of the threat value identifiers.

In another exemplary aspect, the method includes calculating a possible total risk value of a remaining number of the threat value identifiers if each of the plurality of security vulnerabilities where fixed in order to prioritizes the plurality of security vulnerabilities.

In another exemplary aspect, the method includes determining the electronic security remediation action to fix the security vulnerability of the plurality security vulnerabilities having the highest priority based on the security vulnerability resulting in a least total risk value of the enterprise architecture when fixed.

In another exemplary aspect, the method includes executing a plurality of electronic security remediation actions to fix the plurality security vulnerabilities in an order based on the prioritizing of the plurality security vulnerabilities.

In another exemplary aspect of the method, the threat modeling tree is a static data structure that identifies a root security threat and links the plurality of associated threat value identifiers to a plurality of types of critical data that is managed by the at least one asset in the enterprise architecture.

In another exemplary aspect of the method, the scanning of the at least one asset in the enterprise architecture searching data addresses in the at least one asset to determine if the at least one asset contains the type of critical data.

In another exemplary aspect, the method includes determining, by the at least one processor, a number of electronic data records in the at least one asset that fall within the type of critical data, such that the risk value is based at least partially on the determined number of electronic data records.

In another exemplary aspect, the method includes calculating a financial impact value of each of the plurality of security vulnerabilities for the enterprise architecture based on the type of critical data and the number of electronic data records in the at least one asset that fall within the type of critical data; and prioritizing the plurality of security vulnerabilities based on the determined risk value for each of the threat value identifiers multiplied by the calculated financial impact value of the respective security vulnerabilities linked to the respective threat value identifier.

In an exemplary aspect, a system is disclosed for modeling electronic security threats to assets of an enterprise architecture to determine an optimal remediation action to maximize use of security resources. In this aspect, the system includes a threat modeler configured to generate a threat modeling tree that identifies at least one electronic security threat and a plurality of associated threat value identifiers that are each linked to a type of critical data that is threatened by the identified at least one electronic security threat. Moreover, the system includes one or more data analyzers configured to scan at least one asset in the enterprise architecture to determine that the at least one asset contains the identified critical data threatened by the identified at least one electronic security threat. The system further includes at least one processor configured to identify a plurality of security vulnerabilities of the enterprise architecture that each threaten the identified critical data of the scanned at least one asset, determine a risk value for each of the threat value identifiers based on a number and type of security vulnerabilities that threaten the identified critical data that is linked to the respective threat value identifier, prioritize the plurality of security vulnerabilities based on the determined risk value for each of the threat value identifiers, and determine an electronic security remediation action to fix the security vulnerability of the plurality security vulnerabilities having a highest priority, such that the enterprise architecture maximize use of security resources.

By optimizing the threat modeling and remediation selection, the disclosed system and method maximizes selection of remediation resources utilized by an enterprise by automatically identifying the most critical vulnerabilities based on automatically identifying all assets in an enterprise that stored data by the exemplary data analyzers. Upon doing so, the exemplary system and method can thus allocate the necessary software and hardware computing resources for performing the required remediation actions to resolve these identified one or more vulnerabilities.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF DRAWINGS

The accompanying drawings, which are incorporated into and constitute a part of this specification, illustrate one or more example aspects of the present disclosure and, together with the detailed description, serve to explain their principles and implementations.

FIG. 1 illustrates a block diagram of a system for modeling security threats to prioritize threat remediation scheduling according to an exemplary aspect.

FIG. 2 illustrates a block diagram of the enterprise architecture threat modeler of the system shown in FIG. 1 according to an exemplary aspect.

FIG. 3 illustrates an exemplary threat tree generated by the threat tree generator according to an exemplary aspect.

FIG. 4 illustrates a flowchart for assigning a risk value (i.e., “$RiskValue”) for each threat node according to an exemplary aspect.

FIG. 5 illustrates an example of a general-purpose computer system on which the disclosed systems and method can be implemented.

### DETAILED DESCRIPTION

Various aspects are now described with reference to the drawings, wherein like reference numerals are used to refer to like elements throughout. In the following description, for purposes of explanation, numerous specific details are set forth in order to promote a thorough understanding of one or more aspects. It may be evident in some or all instances, however, that any aspect described below can be practiced without adopting the specific design details described below. In other instances, well-known structures and devices are shown in block diagram form in order to facilitate description of one or more aspects. The following presents a simplified summary of one or more aspects in order to provide a basic understanding of the aspects. This summary is not an extensive overview of all contemplated aspects, and is not intended to identify key or critical elements of all aspects nor delineate the scope of any or all aspects.

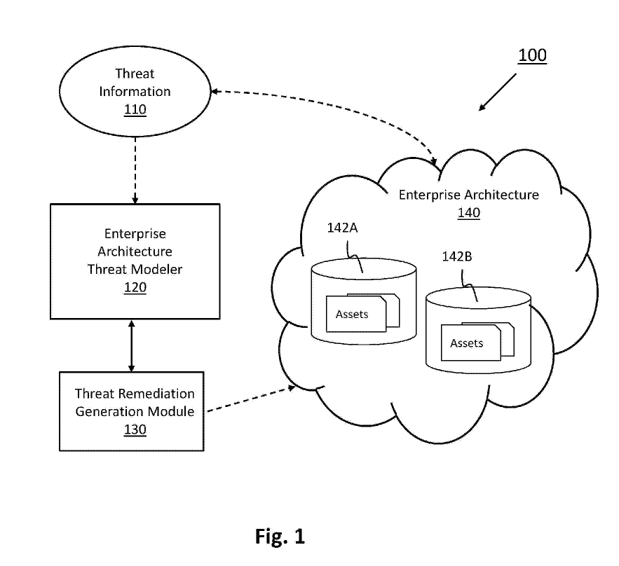

FIG. 1 illustrates a block diagram of a system for modeling security threats to prioritize threat remediation scheduling according to an exemplary aspect. As generally shown, the system 100 comprises an enterprise architecture threat modeler 120 that is configured to receive threat information 110 and work in conjunction with a threat remediation generation module 130 that can generate remediation actions to be applied to the enterprise architecture 140 to fix specific security vulnerabilities in the enterprise architecture 140.

In general, the threat modeling and remediation algorithms can be applied to any type of software and business infrastructure. However, as will become readily apparent from the disclosure below, the threat modeling is most effective on larger scale software systems, such as an enterprise business application that is composed of a collection of computer programs with common business applications, tools for modeling how the entire organization works, and development tools for building applications unique to the organization. Thus, for purposes of this disclosure, the exemplary enterprise architecture threat modeler 120 is configured to perform threat analysis and modeling of enterprise architecture 140 that includes a plurality of assets 142A and 142B, for example, that contain sensitive electronic information, such as social security numbers and salaries. In particular, the example provide to explain the disclosed system and method is for a business in which the assets include an HR system (e.g., asset 142A) that may include employee social security numbers and salary information, and also an XMII system that may include product manufacturing and integrity information. However, it should be appreciated that the disclosed system and method can be provided for threat modeling and analysis of any type and size of enterprise application or similar business software system as would be appreciated to one skilled in the art such as ERP, CRM, SRM, PLM, SCM and other systems.

According to the exemplary aspect, the enterprise architecture threat modeler 120 is generally configured to generate a common threat tree that links threats to assets (e.g., systems 142A and 142B storing electronic data) of a business enterprise to identify risks and potential impact. Thus, the enterprise architecture threat modeler 120 provides the framework to create the threat tree using information about universal threats that target any industry, for example. In general, these threats can be input to the enterprise architecture threat modeler 120 as threat information 110 and be inputted by a system administrator or received as party of a security update, for example.

Moreover, the enterprise architecture threat modeler 120 is configured to identify the particular assets that may be affected by the threat and determine what type of electronic information, or the like, that the assets are responsible managing. In other words, to determine what the assets are responsible for, the enterprise architecture threat modeler 120 is configured to automatically identify the type and content of data that is stored in a particular asset (e.g., an HR database, such as asset 142A) and/or what are the critical processes for which this asset is responsible. Once the responsibilities of the assets are identified, the enterprise architecture threat modeler 120 is further configured to map the assets to the threats. In other words, the enterprise architecture threat modeler 120 is configured to combine the identified threats with the identified assets and with vulnerabilities of these assets based on the potential threats. For example, the threat of stealing personal records will be mapped to the enterprise asset that is responsible for the management of HR electronic data.

Furthermore, according to the exemplary aspect, the enterprise architecture threat modeler 120 is configured to calculate the impact (e.g., the financial impact) of the information based on its potential compromise in the targeted asset. In other words, the enterprise architecture threat modeler 120 calculates the financial impact of a threat based on the information that is the subject of the threat. Thus, in the current example, the enterprise architecture threat modeler 120 estimates the number of personal information records managed by the asset and calculates the impact to the company based on cost per record if it is assumed that the asset is compromised by the threat.

Finally, the enterprise architecture threat modeler 120 is configured to work with (e.g., send instructions and data to) the threat remediation generation module 130 to determine which vulnerabilities are most important to fix (i.e., prioritizing and scheduling the remediation) and how they can be fix. Thus, after all threats that exist in the architecture landscape of the enterprise application are identified and the risk levels are assigned to these identified threats, the disclosed system and method can understand what vulnerabilities need to be fixed first to prevent the maximum number of risks at the same time. As a result, the disclosed system and method is configured to maximize use of computing (and other resources, such as human resources) to address and fix those most important and critical threats based on the calculated priority.

In general, it should be appreciated that the enterprise architecture threat modeler 120 can be a remote computer or server that is remotely coupled to the enterprise architecture according to an exemplary embodiment in order to access asset information using data analyzers as will be described in detail below. Moreover, the threat remediation generation module 130 can be a software component of the enterprise architecture threat modeler 120 or a stand-alone computer. In addition, each of the component shown in FIG. 1 is configured to communicate over one or more remotely communicative networks. Thus, for example, the applicable network can be any network for communicating data and data operations and can include one or more specific communication systems (not shown) that connect the various components of the exemplary system by wire, cable, fiber optic, and/or wireless links facilitated by various types of well-known network elements, such as hubs, switches, routers, and the like. It should be appreciated that the network may employ various well-known protocols to communicate information amongst the network resources. In one aspect, the network can be part of the Internet or intranet using various communications infrastructure such as Ethernet, WiFi, mobile telecommunication networks, and the like.

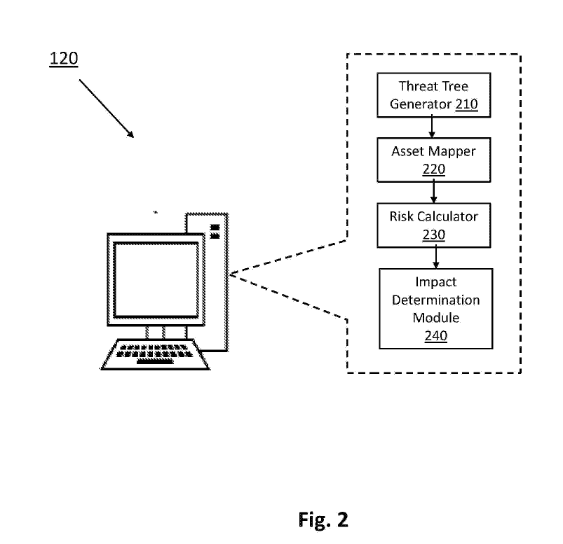

FIG. 2 illustrates a block diagram of the enterprise architecture threat modeler 120 of the system shown in FIG. 1 according to an exemplary aspect. As shown, the enterprise architecture threat modeler 120 comprises a number of software modules and components configured to execute the algorithms described herein. More particularly, according to the exemplary aspect, the enterprise architecture threat modeler 120 includes a threat tree generator 210, an asset mapper 220, a risk calculator 230 and an impact determination module 240.

It is noted that, as used herein, the term “module” refers to a software service or application executed on one or more computers, components, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation exemplified herein.

According to the exemplary aspect, the threat tree generator 210 generator is configured to generate/provide a threat tree that identifies possible threats to the enterprise architecture 140 and software applications. In general, the root threats of an enterprise can be classified as three root threats: espionage, sabotage, fraud which can be selected based on the “CIA triad” (i.e. Confidentiality, Integrity, Availability), which is a well-known model designed to guide policies for information security.

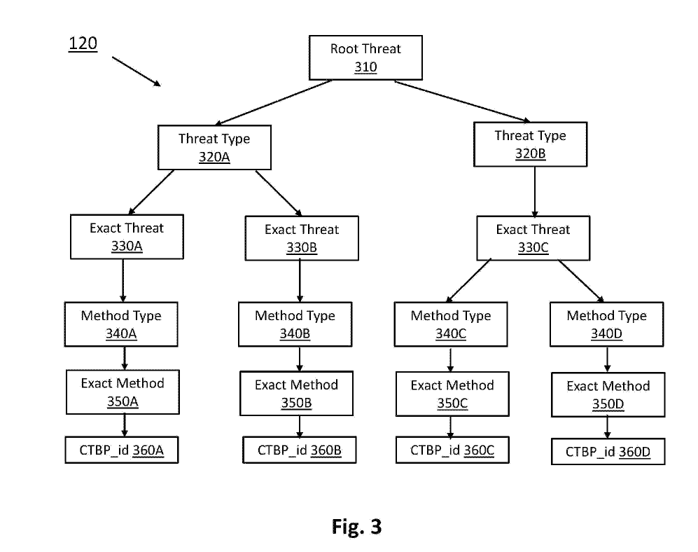

FIG. 3 illustrates an exemplary threat tree generated by the threat tree generator 210 according to an exemplary aspect. According to the exemplary aspect, the threat tree generator 210 is a collection of potential threats (i.e., root threats) that is preconfigured as a static table or configurable by a system administrator. The threat tree is a generic data structure that is not asset specific, meaning that is not yet tied to the specific assets of an enterprise architecture until it is subsequently mapped to architecture assets by asset mapper 220, as will be described in detail below. Thus, as shown, the threat tree 300 (shown as a generic data structure) comprises a top tier of one or more root threats (e.g., root threat 310), which can be more or more of the above-noted threats of espionage, sabotage, fraud. In one aspect, the possible root threats can be received by the enterprise architecture threat modeler 120 as threat information 110.

Once a root threat 310 is identified, the threat tree generator 210 is configured to identify the next tier of the threat tree 300, which is the threat type (e.g., threat type 320A and/or 320B) that can be compromised based on the root threat 310. For example, if the root threat 310 is identified as espionage (e.g., malware, hacker, virus, or the like, configured to steal confidential information), threat tree generator 210 can identify the types of data (e.g., the asset types 320A and 320B) of the enterprise that can be stolen. For example, these types of data can be grouped it into several categories, such as theft of financial information, theft of corporate plans, theft of proprietary information, supplier data theft, employee data theft, customer data theft and the like. In other words, each of these categories 320A and/or 320B, for example, can target possible electronic information, such as confidential employee data, that is stored in one or more of the assets. It should be appreciated that the threat tree generator 210 identifies these threat types as general types of confidential information to the corporate entity that provide business value and are critical in the business operation.

Upon determining the threat types 320A and 320B, the threat tree generator 210 is then configured to identify the next layer of details of the threat tree 300, which is the category identifying information on what exactly can be compromised (e.g., the exact threats 330A, 330B and/or 330C). For example, if the threat type 320A is identified to be employee data theft, the threat tree generator 210 can identify critical data relating to the employee(s), including for example, information about the employees' salaries and/or social security number (SSN) records. Thus, the exact threats 330A to 330C can be applied to one or more of the assets 142A and/or 142B (e.g., HR system or mXII system according to an exemplary aspect) as will be described later with respect to the asset mapper 220.

According to the exemplary aspect, it is assumed that there may be several ways to compromise critical records (i.e., the exact threat 330A, 330B and/or 330C) and different vulnerabilities of the identified assets can be used to simplify one or another method of compromise, which may have more or fewer chances of a successful attack. Accordingly, the threat tree generator 210 is next configured to identify how exact threats can be realized. In other words, the threat tree generator 210 can determine how employees' salaries and/or social security number (SSN) records can be compromised if the asset stores this data. For example, it is generally known that this type of HR data can be stored in SAP ERP System, for example. Thus, the SAP ERP System is understood as a potentially compromised asset, the threat tree generator 210 is further configured to determine (by understanding the structure of the software structure of the asset or manually by user) that a hacker, for example, can get access to confidential electronic data either by using an appropriate transaction or by directly reading a table. Thus, if the exact threat 330C is available for SAP ERP System, then the threat tree generator 210 can further identify the method type 340C as a “transaction” and the method type 340D as a “table”, for example. Once the method type is identified, the threat tree generator 210 is further configured to identify the exact method 350A-350D. For example, each of the “Exact Methods” identified below are exemplary methods of transactions, tables, etc., for how the confidential and critical electronic data can be accessed/stolen.

Finally, the threat tree generator 210 is configured to define a specific threat identifier for each threat starting with the root threat 310 down to the exact method 350A to 350D, for example. Thus, for each threat (e.g., threat ID 1-14), the threat tree generator 210 defines a CTBP_id (i.e., a critical table or business process identifier) 360A to 360D that is configured to link threats, vulnerabilities and assets in order to calculate risks.

Table 1 illustrates an exemplary table of a threat tree:

TABLE 1

| Threat | Threat | | | Method | Exact | |
|---|---|---|---|---|---|---|
| ID | Category | Threat Type | Exact Threat | Type | Method | CTBP_id |
| 1 | ESPIONAGE | Theft of | Financial | Transaction | GRR1 | E_FIN_REP |
| | | financial | Reports | | | |
| | | information | | | | |
| 2 | ESPIONAGE | Theft of | Financial | Transaction | GR55 | E_FIN_REP |
| | | financial | Reports | | | |
| | | information | | | | |
| 3 | ESPIONAGE | Theft of | Financial | Transaction | GR31 | E_FIN_REP |
| | | financial | Reports | | | |
| | | information | | | | |
| 4 | ESPIONAGE | Corporate Plans | Financial | Table | T8PL00 | E_COR_FIN |
| | | | planning | | | |
| 5 | ESPIONAGE | Theft of | Formulas | Transaction | SDV | E_PRO_FOR |
| | | Proprietary | | | | |
| | | information | | | | |
| 6 | ESPIONAGE | Supplier data | Supplier | Transaction | S_ALR_87012086 | E_SUP_PRI |
| | | Theft | Prices | | | |
| 7 | ESPIONAGE | Supplier data | Supplier | Transaction | S_ALR_87012085 | E_SUP_PAY |
| | | Theft | payment | | | |
| | | | history | | | |
| 8 | ESPIONAGE | Employee Data | SSN | Table | PA0001 | E_EMP_SSN |
| | | Theft | | | | |
| 9 | ESPIONAGE | Employee Data | SSN | Table | PA0002 | E_EMP_SSN |
| | | Theft | | | | |
| 10 | ESPIONAGE | Employee Data | Salaries | Table | PA0008 | E_EMP_SAL |
| | | Theft | | | | |
| 11 | ESPIONAGE | Employee Data | SSN | Transaction | PA30 | E_EMP_SSN |
| | | Theft | | | | |
| 12 | ESPIONAGE | Customer Data | Contacts | Programm | RVKUSTA1 | E_CUS_CON |
| | | Theft | | | | |
| 13 | ESPIONAGE | Customer Data | Contacts | Table | VCUST | E_CUS_CON |
| | | Theft | | | | |
| 14 | SABOTAGE | product quality | Product | Process | connections | S_QLT_PRD |
| | | deterioration | | | | |

As shown, each threat ID 1-14 is assigned a CTBP_id 360A to 360D in FIG. 3, although there may be overlap where the two different espionage threats, for example, target the same type of information, such as employee social security numbers (i.e., “E_EMP_SSN”) by threat IDs 8, 9 and 11. The assigned CTBD_ids shown in Table 1 can be used to map assets to threats and assess the financial and business risk of system vulnerabilities as will be discussed in detail below.

Referring back to FIG. 2, the enterprise architecture threat modeler 120 further comprises an asset mapper 220 that is generally configured to link the particular assets to the identified risks. More particularly, to find out the risks of compromising particular assets, the asset mapper 220 is configured to determine what kind of data is stored in the identified asset and/or what the processes this asset is responsible for. For example, in one exemplary aspect, the asset mapper 220 is configured to scan the identified asset to search for a particular table that usually stores known critical data or describes one or more business processes for which the assert is responsible for. In other words, to perform the asset classification, the asset mapper 220 uses a plurality of data analyzers that are configured as specific mechanisms/components/modules that electronically and/or physically connect to the asset, search for critical data in the asset, and then tag this asset with identifying information as well as the size (e.g., number of files or data) of the identified electronic information. Thus, in an exemplary aspect, the asset mapper 220 can be comprised of one or more data analyzers for each type of identified critical information.

For example, for the employee social security number (i.e., “E_EMP_SSN”), a data analyzer can be provided to search for this critical data in the identified asset (e.g., the SAP HR system of the business enterprise) to identify whether this asset stores such HR data. In an exemplary aspect, the data analyzer can be an electronic searching/finding algorithm that electronically (and/or physically) connects to this HR system to read information from the known table “PA0002” (which is known to be a standard SAP Table which is used to store HR Master Record). In this exemplary aspect, the data analyzer can be configured to execute the RFC function RFC READ TABLE, for example. If such data is found in the enterprise's HR system, the asset mapper 220 will set the CTBP_id value to be E_EMP_SSN, meaning that the identified asset (i.e., the HR system) stores employee SSN data. The data analyzer is also configured to determine the number of such data (e.g., the number of employee SSNs) stored in the particular asset.

In another example, the asset mapper 220 can include a separate data analyzer for the employee salary data (i.e., “E_EMP_SAL”), for example. Thus, according to the current example of the SAP HR system, this data analyzer can be configured to identify if the asset stores HR data related to salaries. Thus, the data analyzer can be an electronic searching/finding algorithm that electronically (and/or physically) connects to this HR system to read information from the table “PA0008” (which is also a standard SAP Table which is used to store HR Master Record). Thus, in a similar manner as described above, the data analyzer can be configured to execute an RFC function RFC READ TABLE. If such data is found in the enterprise's HR system, the asset mapper 220 will set the CTBP_id value to be E_EMP_SAL, meaning that the identified asset (i.e., the HR system) stores employee salary data. The data analyzer is also configured to determine the number of such data (e.g., the number of employee salaries) stored in the particular asset.

In another example, the asset mapper 220 can include a separate data analyzer for product quality data (i.e., “S_QLT_PRD”), for example. In particular, in this example, the asset can be an SAP xMII system (i.e., manufacturing integration and intelligence). In this aspect, the asset mapper 220 can include a data analyzer configured to examine if there are insecure connections to an operational technology network of the enterprise, meaning that there is a risk of industrial sabotage. If this data is found in the SAP xMII system, the asset mapper 220 is configured to set the CTBP_ID value to “S_QLT_PRD”, meaning that the compromise of this system may have a negative impact on the products quality.

Thus, it should be appreciated that the asset mapper 220 can include a plurality of data analyzers (e.g., software applications) that are each configured to connect either remotely and/or physically to each corresponding asset and perform a searching algorithm to identify critical data that may be compromised by the identified threat. If the critical data is identified, the asset mapper is configured to link the asset to a particular CTBD_id for subsequent reference and analysis as will be described below.

Moreover, in a refinement of the exemplary aspect, the asset mapper 220 can include a plurality of system analyzers configured to identify the system type in each particular asset. As a result, if the asset mapper 220 knows the system type, the asset mapper 220 can automatically assign the CTBD_ids to the asset. For example, if the asset mapper identifies the asset as an HR system, the asset mapper knows that this system has at least the CTBD_ids “E_EMP_SSN” (for employee SSN numbers) and “E_EMP_SAL” (for employee salary).

Again referring back to FIG. 2, the enterprise architecture threat modeler 120 further comprises a risk calculator 230 that is configured to calculate risks (i.e., business and financial risks) to the enterprise based on the identified threats, vulnerabilities and assets. More particularly, after the threat tree generator 210 generates the threat tree model, as described above, and identified where all the critical data is stored with help of asset mapper 220, the enterprise architecture threat modeler 120 is configured to combine this data with particular vulnerabilities affecting the identified assets and/or particular business processes or data stored in those assets. In other words, the enterprise architecture threat modeler 120 is configured to generate/provide threat trees where each threat is mapped to one or particular types of data or business processes, identify assets where each asset may have issues (i.e., vulnerabilities), and identify system vulnerabilities where each vulnerability affects either a full asset or a particular data process in this asset, for example.

Once this information is generated, the risk calculator 230 is configured to assign a risk_value and risk_impact. In particular, for each threat ID node, the risk calculator 230 is configured to evaluate the assigned CTBP_id for that node (as shown in Table 1) and identify if there are assets in that node (i.e., in the identified asset for the threat) that store this particular CTBP_id. In the exemplary aspect, the risk calculator 230 identifies the one or more vulnerabilities that may affect the asset and/or the one or more vulnerabilities that may affect the particular CTBP_id. Upon determining the one or more vulnerabilities, the risk calculator 230 is configured to calculate a corresponding risk value (i.e., a $RiskValue). For example, if there are no identified vulnerabilities, the risk calculator 230 will calculate a risk value for the particular CTBP_id to be 0 and, therefore, a risk impact (i.e., a $riskImpact) to also be 0 since there is not any determined risk. However, if the risk calculator 230 identifies certain vulnerabilities, but none of them are remotely exploitable without authentication, then the risk calculator 230 will calculate the risk value as “low” since it is unlikely that the vulnerability will lead to an actual data breach. Moreover, if the risk calculator 230 identifies certain vulnerabilities and only one of them is remotely exploitable without authentication, then the risk calculator 230 will calculate the risk value as “medium”. Finally, if the risk calculator 230 identifies certain vulnerabilities and more than one of them is remotely exploitable without authentication, then the risk calculator 230 will calculate the risk value as “high” according to the exemplary aspect.

It should be appreciated that the assigned risk levels of “low”, “medium” and “high” are exemplary and dependent on the particular implementation for the enterprise architecture threat modeler 120. For example, the methods of risk value calculation can vary according to alternative aspects, but generally it is preferable that there are only three risk levels, which will dictate what remediation actions need to be executed urgently, which actions should be scheduled along a mid-term perspective, and which actions should only be scheduled if the required resources are freed up and there is no more critical need for that resource.

As described above, in the current example, it is assumed that there are two assets in the enterprise architecture. For example, these can be the HR system and the xMII system according to the example as described above. Moreover, the enterprise architecture threat modeler 120 is configured to identify the vulnerabilities and link these vulnerabilities to the assets. In general, the architecture vulnerabilities can by identified by the enterprise architecture threat modeler 120 (e.g., by scanning the security infrastructure) or by downloading vulnerability information (e.g., required software updates and the like) from other software products and systems as would be understood to one skilled in the art. Vulnerabilities can include anything from protection of wireless access points to the network of the enterprise to software and anti-malware updates.

In any event, Table 2 illustrates exemplary vulnerabilities that can be identified by the enterprise architecture threat modeler 120 in the assets HR system and xMII system:

TABLE 2

| NAME | Remote | Asset | CTBP_id |
|---|---|---|---|
| Vulnerability1 | Y | HR | E_EMP_SAL |
| | | | E_EMP_SSN |
| Vulnerability2 | Y | HR | E_EMP_SAL |
| | (Table PA0008) | | |
| Vulnerability3 | Y | HR | E_EMP_SSN |
| | (transaction PA30) | | |
| Vulnerability4 | Y | HR | E_EMP_SSN |
| | (transaction PA30) | | |
| Vulnerability5 | Y | HR | E_EMP_SSN |
| | (transaction PA30) | | |
| Vulnerability6 | Y | HR | E_EMP_SSN |
| | (transaction PA30) | | |
| Vulnerability7 | Y | HR | E_EMP_SSN |
| | (transaction PA30) | | |
| Vulnerability8 | Y | HR | E_EMP_SSN |
| | (transaction PA30) | | |
| Vulnerability9 | Y | HR | E_EMP_SSN |
| | (transaction PA30) | | |
| Vulnerability10 | Y | HR | E_EMP_SSN |
| | (transaction PA30) | | |
| Vulnerability11 | Y | HR | E_EMP_SSN |
| | (transaction PA30) | | |
| Vulnerability12 | Y | HR | E_EMP_SSN |
| | (transaction PA30) | | |
| Vulnerability13 | N | xMII | S_QLT_PRD |
| Vulnerability14 | N | xMII | S_QLT_PRD |

Thus, as shown, each vulnerability can be assigned a name (e.g., vulnerability 1-14) and associated with corresponding metadata, such as whether it is a remote vulnerability and the corresponding asset and CTBD_id as described above. Moreover, the type of remote vulnerability (e.g., Table PA0008 versus Transaction PA30) can be included metadata in the Table 2. Thus, the HR asset in this example has the vulnerability1, which is remotely exploitable without authentication and can affect employee salary “E_EMP_SAL” and employee social security number “E_EMP_SSN”. In addition, the HR asset has vulnerability2 that is remotely exploitable without authentication and can also affect employee salary “E_EMP_SAL”. It is noted that in this example, being remotely exploitable without authentication means that there is one user that can remotely access the critical table PA0008 (as identified in Table 1) and reveal information about employee salary “E_EMP_SAL”, such that this vulnerability2 can possibly affect the CTBP_id “E_EMP_SAL”.

As further shown in Table 2, there are 10 vulnerabilities (from vulnerability 3 to vulnerability 12) that can affect the CTBP_id E_EMP_SSN, which means that there can be, for example, 10 users (or remote computing systems or the like) that can perform the critical transaction “PA30” (as identified in Table 1) and access information about employee social security numbers. As a result, these 10 vulnerabilities can affect CTBP_id “E_EMP_SSN” as further identified in Table 2. In addition, Table 2 indicates that the SAP xMII asset has vulnerability13 and vulnerability14, but these vulnerabilities cannot be exploited without authentication (i.e., the remote metadata indicator is “NO”).

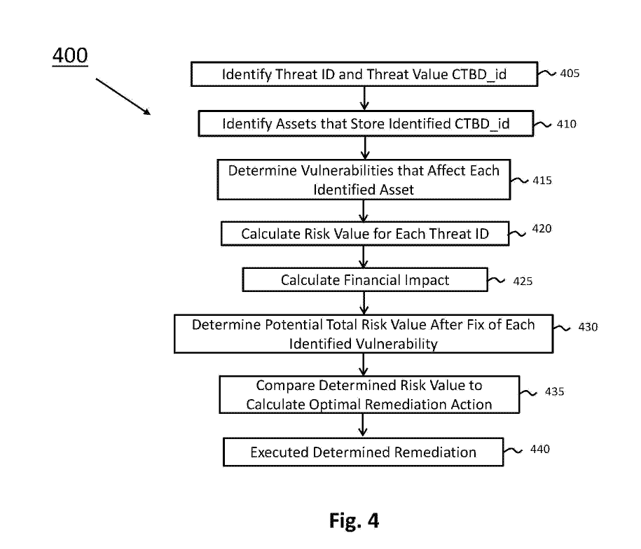

FIG. 4 illustrates a flowchart for assigning a risk value (i.e., “$RiskValue”) for each threat node. It is noted that for purposes of the description of method 400, the enterprise architecture threat modeler 120 is described to perform each stated step of the method 400. However, it should be appreciated that the one or more specific components/modules described above with respect to FIG. 2 can be configured to perform the corresponding steps as described herein.

Thus, as initially shown at step 405, the enterprise architecture threat modeler 120 is configured to access a first threat tree node (e.g., threat ID=1 from threat tree of Table 1) and the corresponding threat value CTBP_id that is assigned to the threat tree node. Thus, for example, the CTBP_id of the first threat tree node 1 is accessed as “E FIN REP” as shown above. Once this value is determined, the enterprise architecture threat modeler 120 is next configured to identify if there are any assets of the enterprise architecture that store this particular CTBP_id (step 410). In the exemplary enterprise architecture described above, there are two system (i.e., the HR asset and the xMII asset). As such, the enterprise architecture threat modeler 120 is configured to determine that there are only risks with CTBP_ids “E_EMP_SSN”, “E_EMP_SAL” and “S_QLT_PRD”, as shown in Table 2, for example. In other words, these are the risks associated with the threat IDs 8, 9, 10, 11, and 14, as shown in Table 1, as these risks have CTBD_ids of “E_EMP_SSN”, “E_EMP_SAL” and “S_QLT_PRD” as shown above in Table 2.

Next, at step 415, the enterprise architecture threat modeler 120 is further configured to determine the vulnerabilities that may affect each asset by referring to Table 2. In other words, the enterprise architecture threat modeler 120 determines the number and type of each vulnerability that may affect the assets to the particular CTBD_id associated with the asset. Accordingly, as shown above, for the HR asset, the enterprise architecture threat modeler 120 first determines that for threat IDs 8 and 9 (i.e., associated with CTBD_id=E_EMP_SSN), there is 1 vulnerability that is remotely exploitable (i.e., vulnerability1) for each such node as there is only one vulnerability that is remotely exploitable for each node since there is one person that can remotely access this information without authentication. It is noted that all vulnerabilities are not equal as shown above in Table 2. For example, certain vulnerabilities threaten a whole system, such as vulnerability1, where therefore affects all threats (i.e., all of threat IDs 8, 9, 10, 11, and 14). Other vulnerabilities threat only a particular access, such as vulnerability2, which only allows access to specific table PA0008, and, therefore, only threat ID 10 is subject to this vulnerability, for example

Moreover, for threat ID node 10 (i.e. “E_EMP_SAL”), there are 2 vulnerabilities that are remotely exploitable (i.e., vulnerability1 and vulnerability2) and for threat ID node 11 (i.e. “E_EMP_SSN”), there are 11 vulnerabilities that are remotely exploitable (i.e., vulnerability1 and vulnerabilities from 3 to 12). In addition, for the asset xMII, the threat ID node 14 is identified and has two vulnerabilities (i.e., vulnerability13 and vulnerability14), but are not remotely exploitable as indicated in Table 2.

As further shown in FIG. 4, the enterprise architecture threat modeler 120 (and particularly the risk calculator 230) calculates the risk value for each threat node (i.e., each threat ID) at step 420. That is, according to the exemplary described above, for the threat node IDs 8 and 9, the enterprise architecture threat modeler 120 calculates a risk value of “medium” since there is only one vulnerability (i.e., vulnerability1) that is remotely exploitable. Moreover, for each of the threat IDs 10 and 11, the risk value is “high” since there are two or more vulnerabilities that are remotely exploitable. More particularly, there are two vulnerabilities (i.e., vulnerability1 and vulnerability2) for threat ID 10. There are eleven vulnerabilities (i.e., vulnerability1 and vulnerability3-12) for threat ID 11. Finally, for the threat node ID 14, the risk value is determined to be “low” since are zero vulnerabilities that are remotely exploitable. Again, it is reiterated that the risk value rankings of “low”, “medium” and “high” are configurable and can be set by a system administrator in one exemplary aspect. For example, the enterprise architecture threat modeler 120 can include a user interface that enables the user to define the number and type of vulnerabilities required to classify a given threat ID as either “low” or “medium” or “high”.

Referring back to FIG. 2 described above, once the risk values are assigned for each node, the enterprise architecture threat modeler 120 is further configured to calculate a financial impact based on the critical electronic information that is stored in the respective asset and is potentially compromised by the vulnerabilities identified above. Thus, as further shown in FIG. 4, at step 425, the enterprise architecture threat modeler 120 (and in particular the impact determination module 240) is configured to calculate the financial impact (i.e., the “$FinanceImpact”). Thus, in this step, the impact determination module 240 first determines the number of records stored in a particular table or available via a transaction for each relevant threat ID. Based on the number of compromised records, the impact determination module 240 can calculate the potential financial impact based on the vulnerability. For example, for the root threat of sabotage, the impact determination module 240 is configured to estimate the revenue losses based on the year revenue and the system downtime, which may be predetermined by a system administrator based on previous threats, for example. In other words, the enterprise architecture threat modeler 120 can include an electrode database that stores a financial impact for each type of record and corresponding data breach. For example, the database can include information that indicates that the cost of personal records (e.g., SSN) data breach is approximately $150 per record, the cost of healthcare records data breach is approximately $300 per record, and the cost of modification fraud of salary is about 50% of employee salary.

Once the potential financial impacts for each type of record are identified, the enterprise architecture threat modeler 120 is configured to determine what vulnerabilities need to be fixed to prevent the maximum number of problematic cases at the same time while maximizing the use of remediation resources to do so. Thus, according to an exemplary aspect, the enterprise architecture threat modeler 120 is configured to identify how many risks can be mitigated by fixing each vulnerability. Using the current example, the HR system asset is susceptible to two “medium” risks (i.e., threat ID nodes 8 and 9) and two “high” risks (i.e., threat ID nodes 10 and 11).

Accordingly, at step 430, the enterprise architecture threat modeler 120 is configured to calculate the potential remaining threats and risk values if each vulnerability is fix. For example, if the system fixes the vulnerability1 in the HR asset, there will be 1 remaining threat with a “medium” risk value and 1 remaining threat with a “high” risk value. Moreover, if the system fixes the vulnerability2 that affects the CTBP_id “E_EMP_SAL”, there will be 3 remaining threats with “medium” risk value and 1 remaining threat with a “high” risk value. Finally, if the system fixes any of the vulnerabilities which affect CDBP_E_EMP_SSN, we will have 2 threats with medium and 2 threats with high risk.

Accordingly, it should be clear that the impact determination module 240 is configured to evaluate the resulting number of risks and risk values if it were to fix each vulnerability. In other words, the impact determination module 240 can calculate the how many risks and risks values would be left if each of vulnerabilities 1-14 (in Table 2) were fixed. It is noted that vulnerabilities 13 and 14 were noted discussed above since there risk values were calculated to be “low”. Thus, there are three possible outcomes if any of vulnerabilities 1-12 were fix: (i) one “medium” ranked threat and one “high” ranked threat; (ii) three “medium” ranked threats and one “high” ranked threat; or (iii) two “medium” ranked threats and two “high” ranked threats

In this simplified example, it is easy to see that option (i) is the optimal choice since there is only one “medium” ranked threat and one “high” ranked threat, which is less than either of options (ii) or (iii). However, according to an exemplary aspect, each type of risk may be assigned a weighted value. For example, in one aspect, a system administrator can define the weights, such as, for example, 3 “low” risk threats are equal to 1 “medium” risk threat, and 3 “medium” risk threats are equal to one “high” risk threat. Thus, the outcome (i) could have a ranking of “12” (i.e., one medium risk have a value 3 and one high risk having a value 9); the outcome (ii) could have a ranking of “18” (i.e., three medium risks each having values 3 and one high risk having a value 9); and outcome (iii) having a ranking of “24” (i.e., two medium risks each having values 3 and two high risk each having a value 9). Accordingly, this variable ranking confirms at step 435 that option (i), which is to fix vulnerability1 is the optimal outcome. According to yet a refinement of the exemplary aspect, the impact determination module 240 can also ranks vulnerabilities based on the value of the financial impact (i.e., the “$FinanceImpact”) as previously described. For example, in one aspect, this value for each CTBP_id and associated vulnerability can be combined with a current risk value or can be applied separately. In other words, the criticality of each vulnerability for each threat can be multiplied by the value of the financial impact (i.e., the “$FinanceImpact”) to determine an updated optimal outcome.

Finally, at step 440, the enterprise architecture threat modeler 120 is configured to provide its optimal threat remediation determination to the threat remediation generation module. Based on this identification as vulnerability1 being the most critical vulnerability to fix, the threat remediation generation module can determine the appropriate remediation action (e.g., software patch, software installation or update, or the like) that can be provided to the relevant asset of the enterprise architecture 140 for remediation. As a result, by optimizing the threat modeling and remediation selection, the enterprise architecture threat modeler 120 is configured to maximize selection of resources by automatically identifying the most critical vulnerabilities (based on automatically identifying all assets in an enterprise that stored data by the exemplary data analyzers) as described above, and allocating the necessary software and hardware computing resources for performing the required remediation actions to resolve these identified one or more vulnerabilities.

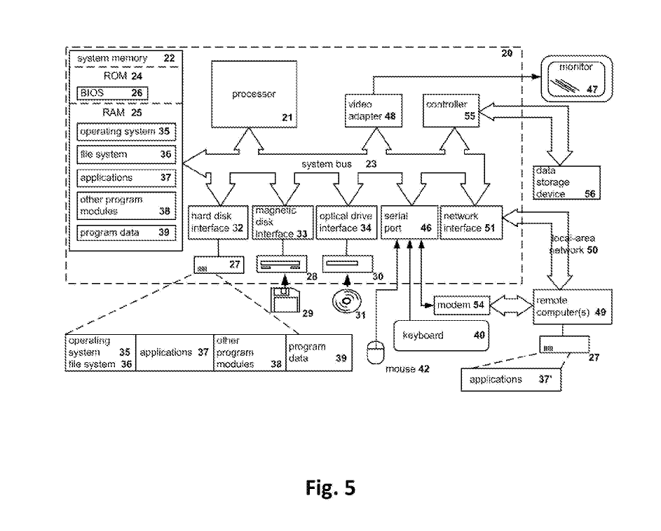

FIG. 5 illustrates an example of a general-purpose computer system (which may be a personal computer or a server) on which the disclosed systems and method can be implemented according to an example aspect. It should be appreciated that the detailed general-purpose computer system can correspond to a configured to implement the enterprise architecture threat modeler 120 and/or threat remediation generation module 130 for implementing the exemplary algorithms described above.

As shown, the computer system 20 includes a central processing unit 21, a system memory 22 and a system bus 23 connecting the various system components, including the memory associated with the central processing unit 21. Furthermore, the system bus 23 is realized like any bus structure known from the prior art, including in turn a bus memory or bus memory controller, a peripheral bus and a local bus, which is able to interact with any other bus architecture. The system memory includes read only memory (ROM) 24 and random-access memory (RAM) 25. The basic input/output system (BIOS) 26 includes the basic procedures ensuring the transfer of information between elements of the personal computer 20, such as those at the time of loading the operating system with the use of the ROM 24.

The personal computer 20, in turn, includes a hard disk 27 for reading and writing of data, a magnetic disk drive 28 for reading and writing on removable magnetic disks 29 and an optical drive 30 for reading and writing on removable optical disks 31, such as CD-ROM, DVD-ROM and other optical information media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the personal computer 20.

The present disclosure provides the implementation of a system that uses a hard disk 27, a removable magnetic disk 29 and a removable optical disk 31, but it should be understood that it is possible to employ other types of computer information media 56 which are able to store data in a form readable by a computer (solid state drives, flash memory cards, digital disks, random-access memory (RAM) and so on), which are connected to the system bus 23 via the controller 55.

The computer 20 has a file system 36, where the recorded operating system 35 is kept, and also additional program applications 37, other program modules 38 and program data 39. The user is able to enter commands and information into the personal computer 20 by using input devices (keyboard 40, mouse 42). Other input devices (not shown) can be used: microphone, joystick, game controller, scanner, and so on. Such input devices usually plug into the computer system 20 through a serial port 46, which in turn is connected to the system bus, but they can be connected in other ways, for example, with the aid of a parallel port, a game port or a universal serial bus (USB). A monitor 47 or other type of display device is also connected to the system bus 23 across an interface, such as a video adapter 48. In addition to the monitor 47, the personal computer can be equipped with other peripheral output devices (not shown), such as loudspeakers, a printer, and so on.

The personal computer 20 is able to operate within a network environment, using a network connection to one or more remote computers 49. The remote computer (or computers) 49 are also personal computers or servers having the majority or all of the aforementioned elements in describing the nature of a personal computer 20. Other devices can also be present in the computer network, such as routers, network stations, peer devices or other network nodes. According to one exemplary aspect, the remove computer(s) 49 can correspond to one or more of the system assets 142A and/or 142B of enterprise architecture 140, for example, as discussed above.

Network connections can form a local-area computer network (LAN) 50, such as a wired and/or wireless network, and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the personal computer 20 can employ a modem 54 or other modules for providing communications with a wide-area computer network such as the Internet. The modem 54, which is an internal or external device, is connected to the system bus 23 by a serial port 46. It should be noted that the network connections are only examples and need not depict the exact configuration of the network, i.e., in reality there are other ways of establishing a connection of one computer to another by technical communication modules, such as Bluetooth.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed:

1. A method for modeling electronic security threats to assets of an enterprise architecture to determine an optimal remediation action to maximize use of security resources, the method comprising:
providing a threat modeling tree that identifies at least one electronic security threat and a plurality of associated threat value identifiers that are each linked to a type of critical data that is threatened by the identified at least one electronic security threat;
scanning at least one asset in the enterprise architecture to determine that the at least one asset contains the identified critical data threatened by the identified at least one electronic security threat;
identifying, by at least one processor, a plurality of security vulnerabilities of the enterprise architecture that each threaten the identified critical data of the scanned at least one asset;
determining, by the at least one processor, a risk value for each of the threat value identifiers based on a number and type of security vulnerabilities that threaten the identified critical data that is linked to the respective threat value identifier;
prioritizing, by the at least one processor, the plurality of security vulnerabilities based on the determined risk value for each of the threat value identifiers; and
determining, by the at least one processor, an electronic security remediation action to fix the security vulnerability of the plurality security vulnerabilities having a highest priority, such that the enterprise architecture maximize use of security resources.

2. The method according to claim 1, wherein the determining of the risk value for each of the threat value identifiers comprises assigning one of a plurality of tiers of risk values based on the number of security vulnerabilities and whether each security vulnerability is remotely exploitable.

3. The method according to claim 2, wherein each of the threat value identifiers is assigned a risk value tier of low, medium or high.

4. The method according to claim 2, further comprising applying a different weighting factor to each of the plurality of tiers of risk values in order to prioritize the plurality of security vulnerabilities based on a sum of the weighted risk values for each of the threat value identifiers.

5. The method according to claim 1, further comprising:
calculating a possible total risk value of a remaining number of the threat value identifiers if each of the plurality of security vulnerabilities where fixed in order to prioritizes the plurality of security vulnerabilities; and
determining the electronic security remediation action to fix the security vulnerability of the plurality security vulnerabilities having the highest priority based on the security vulnerability resulting in a least total risk value of the enterprise architecture when fixed.

6. The method according to claim 1, further comprising executing a plurality of electronic security remediation actions to fix the plurality security vulnerabilities in an order based on the prioritizing of the plurality security vulnerabilities.

7. The method according to claim 1, wherein the threat modeling tree is a static data structure that identifies a root security threat and links the plurality of associated threat value identifiers to a plurality of types of critical data that is managed by the at least one asset in the enterprise architecture.

8. The method according to claim 1, wherein the scanning of the at least one asset in the enterprise architecture searching data addresses in the at least one asset to determine if the at least one asset contains the type of critical data.

9. The method according to claim 8, further comprising determining, by the at least one processor, a number of electronic data records in the at least one asset that fall within the type of critical data, such that the risk value is based at least partially on the determined number of electronic data records.

10. The method according to claim 9, further comprising:
calculating a financial impact value of each of the plurality of security vulnerabilities for the enterprise architecture based on the type of critical data and the number of electronic data records in the at least one asset that fall within the type of critical data; and
prioritizing the plurality of security vulnerabilities based on the determined risk value for each of the threat value identifiers multiplied by the calculated financial impact value of the respective security vulnerabilities linked to the respective threat value identifier.

11. A system for modeling electronic security threats to assets of an enterprise architecture to determine an optimal remediation action to maximize use of security resources, the system comprising:
a threat modeler configured to generate a threat modeling tree that identifies at least one electronic security threat and a plurality of associated threat value identifiers that are each linked to a type of critical data that is threatened by the identified at least one electronic security threat;
a data analyzer configured to scan at least one asset in the enterprise architecture to determine that the at least one asset contains the identified critical data threatened by the identified at least one electronic security threat; and
at least one processor configured to:
identify a plurality of security vulnerabilities of the enterprise architecture that each threaten the identified critical data of the scanned at least one asset,
determine a risk value for each of the threat value identifiers based on a number and type of security vulnerabilities that threaten the identified critical data that is linked to the respective threat value identifier,
prioritize the plurality of security vulnerabilities based on the determined risk value for each of the threat value identifiers, and
determine an electronic security remediation action to fix the security vulnerability of the plurality security vulnerabilities having a highest priority, such that the enterprise architecture maximize use of security resources.

12. The system according to claim 11, wherein the at least one processor is further configured to determine of the risk value for each of the threat value identifiers comprises assigning one of a plurality of tiers of risk values based on the number of security vulnerabilities and whether each security vulnerability is remotely exploitable.

13. The system according to claim 12, wherein each of the threat value identifiers is assigned a risk value tier of low, medium or high.

14. The system according to claim 12, wherein the at least one processor is further configured to apply a different weighting factor to each of the plurality of tiers of risk values in order to prioritize the plurality of security vulnerabilities based on a sum of the weighted risk values for each of the threat value identifiers.

15. The system according to claim 11, wherein the at least one processor is further configured to:
calculate a possible total risk value of a remaining number of the threat value identifiers if each of the plurality of security vulnerabilities where fixed in order to prioritizes the plurality of security vulnerabilities, and
determine the electronic security remediation action to fix the security vulnerability of the plurality security vulnerabilities having the highest priority based on the security vulnerability resulting in a least total risk value of the enterprise architecture when fixed.

16. The system according to claim 11, wherein the at least one processor is further configured to execute a plurality of electronic security remediation actions to fix the plurality security vulnerabilities in an order based on the prioritizing of the plurality security vulnerabilities.

17. The system according to claim 11, wherein the threat modeling tree is a static data structure that identifies a root security threat and links the plurality of associated threat value identifiers to a plurality of types of critical data that is managed by the at least one asset in the enterprise architecture.

18. The system according to claim 11, wherein the at least one processor scans the at least one asset in the enterprise architecture searching data addresses in the at least one asset to determine if the at least one asset contains the type of critical data.

19. The system according to claim 18, wherein the at least one processor is further configured to determine a number of electronic data records in the at least one asset that fall within the type of critical data, such that the risk value is based at least partially on the determined number of electronic data records.

20. The system according to claim 19, wherein the at least one processor is further configured to:
calculate a financial impact value of each of the plurality of security vulnerabilities for the enterprise architecture based on the type of critical data and the number of electronic data records in the at least one asset that fall within the type of critical data; and
prioritize the plurality of security vulnerabilities based on the determined risk value for each of the threat value identifiers multiplied by the calculated financial impact value of the respective security vulnerabilities linked to the respective threat value identifier.
